(19) United States
(12) Patent Application Publication
(10) Pub. No.: US 2013/0142582 A1
(43) Pub. Date: Jun. 6, 2013

(54) Head Replaceable Cutting Tool

(71) Applicant: TaeguTec, Ltd., Dalseong-gun (KR)

(72) Inventor: Chul Ho LEE, Dalseong-gun (KR)

(73) Assignee: TaeguTec, Ltd., Dalseong-gun (KR)

(21) Appl. No.: 13/705,549

(22) Filed: Dec. 5, 2012

(30) Foreign Application Priority Data
Dec. 6, 2011 (KR) 10-2011-0129579

(51) Int. Cl. B23B 29/02

(52) U.S. Cl. CPC B23B 29/02; B23B 29/025
USPC 408/226; 408/199

(57) ABSTRACT

A cutting tool has a cutting head and a shank. The cutting head has a body, a head threaded portion, a first helical head surface and a second helical head surface. The shank has a cylindrical portion, a shank threaded portion, a first helical contact surface and a second helical contact surface. The head threaded portion screw-engages the shank threaded portion. The first helical head surface is parallel to the thread of the head threaded portion and the first helical contact surface is parallel to the thread of the shank threaded portion. The second helical head surface and the second helical contact surface are inclined reversely to the first helical head surface and the first helical contact surface, respectively. The first helical head surface comes into surface contact with the first helical contact surface. The second helical head surface comes into surface contact with the second helical contact surface.

### CROSS-REFERENCE TO RELATED APPLICATIONS

This application claims priority from Korean Patent Application No. 10-2011-0129579 filed on Dec. 6, 2011, the entire subject matter of which is incorporated herein by reference.

### TECHNICAL FIELD

The present disclosure relates to a cutting tool wherein its cutting head is replaceable. Further, the present disclosure relates to a cutting head and a shank for such a cutting tool.

### BACKGROUND

A cutting tool with a replaceable cutting head can be reused by replacing the cutting head with another one when the cutting head malfunctions. It also provides various types of cutting operations by optionally coupling various types of cutting heads to a shank.

Conventional head replaceable cutting tools employ at least one screw to couple a cutting head to a shank. To keep the height and position of the cutting head to a certain degree, conventional cutting tools need to predetermine the position of the screw or have a projection for such a purpose.

As an example of a prior art head replaceable cutting tool, Japanese Laid-Open Patent Publication No. 2001-225211 discloses a cutting tool wherein a cutting head is coupled to a shank by fastening a clamp screw to screw holes provided in the cutting head and the shank. Particularly, the aforementioned document discloses that a coupling force between the cutting head and the shank is strengthened by engagement of an anti-rotation recess of the shank with a projection of the cutting head. However, the cutting tool disclosed by the aforementioned document must employ the clamp screw for providing the coupling force between the cutting head and the shank. In such a case, the coupling force is merely provided by the clamp screw only, and thus, a stress may concentrate on the clamp screw. This may cause a deformation of the clamp screw and fail to accurately position the cutting head to the shank in a predetermined position.

As another example of a prior art head replaceable cutting tool, Korean Laid-Open Patent Publication No. 10-2003-0046913 discloses a coupling device for a cutting tool, which strongly couples a cutting edge portion to a shank. The cutting edge portion has a cam-shaped mounting portion at its end and the shank has a coupling portion to which the mounting portion is inserted and mounted at its end. However, the coupling device disclosed by the aforementioned document is configured so that a portion of the cutting edge portion is elastically deformed and then press-fitted to the shank. In such a case, a final position of the cutting edge portion relative to the shank can vary depending on the degree of elastic deformation. This does not provide the constant final position of the cutting edge portion and needs an additional part such as an anti-rotation pin for constantly maintaining the coupling force between the cutting edge portion and the shank.

### SUMMARY

The present disclosure provides embodiments of a cutting tool wherein a cutting head is replaceably coupled to a shank as well as embodiments of a cutting head and a shank. Embodiments of the cutting tool disclosed herein provide screw-engagement between a cutting head and a shank without the use of various parts. Further, embodiments of the cutting tool disclosed herein allow the cutting head to be positioned in a constant position by preventing rotation between the cutting head and the shank, which may be caused by an additional coupling force or a cutting force after the cutting head contacts the shank.

In one exemplary embodiment, by way of non-limiting example, a cutting tool includes a cutting head and a shank coupled to the cutting head. The cutting head includes a body, a head threaded portion, a first helical head surface and a second helical head surface. The body extends in an axial direction. The head threaded portion has a thread and projects or is recessed in the axial direction from a rear end of the body facing toward the shank. The first helical head surface is parallel to a helix of the thread of the head threaded portion at the rear end of the body. The second helical head surface is inclined reversely to the first helical head surface and is disposed alternatingly with the first helical head surface at the rear end of the body. The shank includes a cylindrical portion, a shank threaded portion, a first helical contact surface and a second helical contact surface. The cylindrical portion extends in the axial direction. The shank threaded portion extends in the axial direction from a forward end of the cylindrical portion facing toward the cutting head. The shank threaded portion screw-engages the head threaded portion. The first helical contact surface corresponds to the first helical head surface of the cutting head. The second helical contact surface corresponds to the second helical head surface of the cutting head and is disposed alternatingly with the first helical contact surface at the forward end of the cylindrical portion. When the cutting head is coupled to the shank, the first helical head surface comes into surface contact with the first helical contact surface and the second helical head surface comes into surface contact with the second helical contact surface.

In yet another embodiment, a cutting head is detachably coupled to a shank of a cutting tool. The cutting head includes a body having a rear end, a head threaded portion, a first helical head surface and a second helical head surface. The body extends in an axial direction. The head threaded portion has a thread and projects or is recessed in the axial direction from the rear end of the body facing toward the shank. The first helical head surface is parallel to a helix of the thread of the head threaded portion at the rear end of the body. The second helical head surface is inclined reversely to the first helical head surface and is disposed alternatingly with the first helical head surface at the rear end of the body. When the cutting head is coupled to the shank, the first and second helical head surfaces come into surface contact with opposing surfaces of the shank.

In still yet another embodiment, a shank of a cutting tool, which is detachably coupled to a cutting head, includes a cylindrical portion having a forward end, a shank threaded portion, a first helical contact surface and a second helical contact surface. The cylindrical portion extends in an axial direction. The shank threaded portion has a thread and projects or is recessed in the axial direction from the forward end of the cylindrical portion facing toward the cutting head. The first helical contact surface is parallel to the thread of the shank threaded portion at the forward end of the cylindrical portion. The second helical contact surface is inclined reversely to the first helical contact surface and is disposed alternatingly with the first helical contact surface at the forward end of the cylindrical portion. When the cutting head is coupled to the shank, the first and second helical contact surfaces come into surface contact with opposing surfaces of the cutting head.

This Summary is provided to introduce a selection of concepts in a simplified form that are further described below in the detailed description. This Summary is not intended to identify key or essential features of the claimed subject matter, nor is it intended to be used in determining the scope of the claimed subject matter.

### BRIEF DESCRIPTION OF THE DRAWINGS

FIG. 1 is a perspective view showing a cutting tool according to one embodiment.

FIG. 2 is a perspective view of a cutting head shown in FIG. 1.

FIG. 3 is a perspective view of a shank shown in FIG. 1.

FIGS. 4 to 6 are side views schematically showing an example coupling between the cutting head and the shank shown in FIG. 1.

FIG. 7 is a sectional view showing that the cutting head and the shank shown in FIG. 1 are coupled to each other.

FIG. 8 is a front view showing a shank having two first helical contact surfaces and two second helical contact surfaces.

FIG. 9 is a front view showing a shank having three first helical contact surfaces and three second helical contact surfaces.

FIG. 10 is a perspective view showing a shank having a non-contact surface according to another embodiment.

FIG. 11 is a side view showing that the cutting head shown in FIG. 1 is coupled to the shank shown in FIG. 10.

### DETAILED DESCRIPTION

A detailed description may be provided with reference to the accompanying drawings. One of ordinary skill in the art may realize that the following description is illustrative only and is not in any way limiting. Other embodiments may readily suggest themselves to such skilled persons having the benefit of this disclosure.

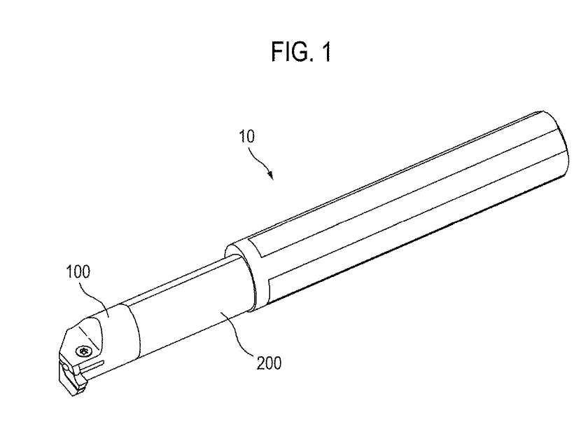

FIG. 1 schematically shows a cutting tool 10 according to one embodiment wherein a replaceable cutting head 100 is coupled to a shank 200.

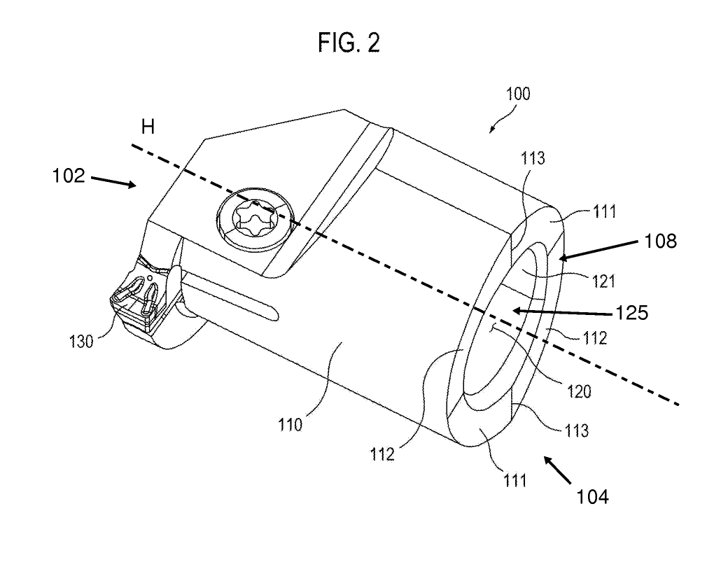

FIG. 2 shows a cutting head 100 according to one embodiment. The cutting head 100 includes a body 110 having a head forward end 102 and a head rear end 104. The body 110 extends along a head axis H in the same axial direction as a shank axis S of the shank when the cutting head is coupled to the shank. The body 110 may have a cylindrical shape, an elliptic cylindrical shape or any shape in accordance with a shape of the shank 200. The body 110 may have a key way which a spanner engages when the cutting head 100 is coupled to the shank 200.

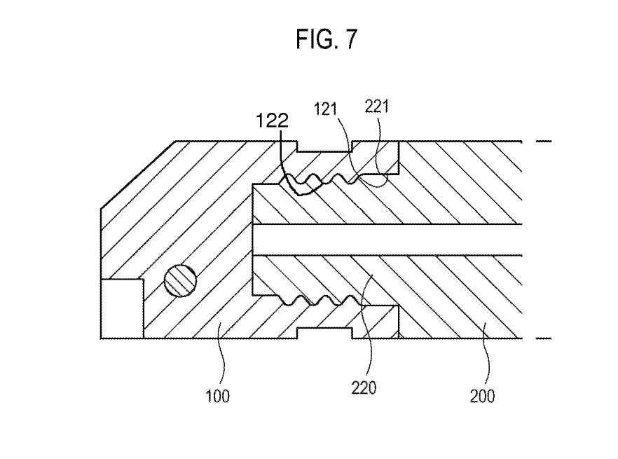

The body 110 includes a head threaded portion 120 at the head rear end 104 facing toward the shank 120. The head threaded portion 120 projects or is recessed in the axial direction of the body 110. As an example of the head threaded portion 120, FIG. 2 shows a threaded bore 125 that is recessed and extends in the axial direction of the body 110. A thread 122 (see FIG. 7) is formed on a portion or the entirety of an inner peripheral surface of the head threaded portion 120. Accordingly, the cutting head 100 includes a female screw portion for screw-engagement with a male screw portion of the shank 200.

The head threaded portion 120 may further include a centering means 121 that helps centering between the cutting head 100 and the shank 200. The centering means 121 may comprise a cylindrical portion or a cylindrical bore that engages a cylindrical bore or a cylindrical portion provided in the shank 200 as a counter-centering means 221. As an example of the centering means 121 of the head threaded portion 120, FIG. 7 shows a smooth cylindrical bore that is provided on the inner peripheral surface of the head threaded portion 120 and does not have a thread.

The body 110 has one or more cutting edges 130 at, or near, its opposite forward end 102. The cutting edge 130 may be integrally formed with the cutting head 100. Alternatively, one or more cutting inserts with a cutting edge may be replaceably mounted to the cutting head 100.

At the head rear end 104, the body 110 has a circumferentially extending head end face 108 surrounding the head threaded portion 120. The body 110 has opposing surfaces 111, 112 formed on the head end face 108 of the head rear end 104, the surfaces 111, 112 facing toward the shank 200. The opposing surfaces 111 are opposed to each other about the head axis H of the body 110, while the opposing surfaces 112 are opposed to each other about the head axis H of the body 110. When the cutting head 100 is coupled to the shank 200, the opposing surfaces 111, 112 come into contact with corresponding opposing surfaces of the shank 200. One of the opposing surfaces 111, 112 comprises a first helical head surface 111 that is helically formed parallel to the thread 122 of the head threaded portion 120. The other of the opposing surfaces 111, 112 comprises a second helical head surface 112 that is inclined reversely to the inclination of the first helical head surface 111. Thus, the head end face 108, which faces toward the shank 200, of the body 110 of the cutting head 100, is not flat due to the opposing surfaces 111, 112. The lengths in the axial direction of the cutting head 100 are different due to the opposing surfaces 111, 112. The first and second helical head surfaces 111, 112 are alternatingly arranged. One or more first helical head surfaces 111 and one or more second helical head surfaces 112 may be alternatingly arranged. Other embodiment may include alternatingly-arranged three or more helical head surfaces.

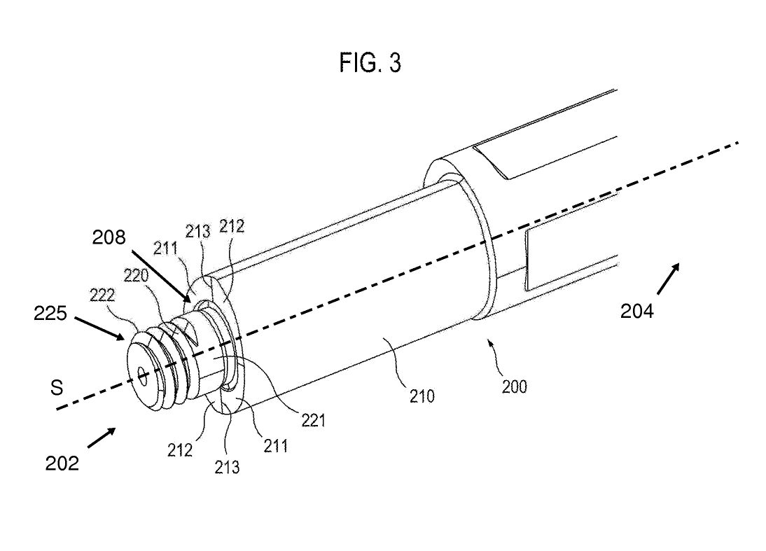

FIG. 3 shows the shank 200 according to one embodiment. The shank 200 includes a cylindrical portion 210 that extends along the shank axis S in the same axial direction as the cutting head 100 when the cutting head 100 is coupled to the shank 200. The cylindrical portion 210 may have a shape of a rod having a circular or elliptical cross section. A channel through which a coolant flows may extend through a center of the cylindrical portion 210 in the axial direction of the shank 200.

The cylindrical portion 210 includes a shank threaded portion 220 at a shank forward end 202 facing toward the cutting head 100. The shank threaded portion 220 extends in the axial direction and the head threaded portion 120 engages the shank threaded portion 220. As an example of the shank threaded portion 220, FIG. 3 shows a projection 225 that projects in the axial direction of the shank 200. A shank thread 222 is formed on an outer peripheral surface of the shank threaded portion 220. The shank threaded portion 220 with the shank thread 222 constitutes the male screw portion of the shank 200 and screw-engages the female screw portion of the cutting head 100 (i.e., the head threaded portion 120). The shank threaded portion 220 includes the centering means 221 that engages the centering means 121 of the cutting head 100 to effectuate the centering between the cutting head 100 and the shank 200. As an example of the centering means 221 of the shank threaded portion 220, FIG. 7 shows a smooth cylindrical portion, which is provided in a portion of the shank threaded portion 220 and does not have the thread. The cylindrical portion 210 includes a mounting portion, which is coupled to a cutting apparatus and receives a power from the cutting apparatus, at its opposite rear end 204.

At the shank forward end 202, the cylindrical portion 210 has a circumferentially extending shank end face 208 surrounding the shank threaded portion 220. The cylindrical portion 210 includes opposing surfaces 211, 212 formed on the shank end face 208, the opposing surfaces 211, 212 facing toward the cutting head 100. When the cutting head 100 is coupled to the shank 200, the opposing surfaces 211, 212 come into contact with the opposing surfaces 111, 112 of the cutting head 100. The opposing surfaces 211 are opposed to each other about the shank axis S of the cylindrical portion 210, while the opposing surfaces 212 are also opposed to each other about the same shank axis S. One of the opposing surfaces 211, 212 comprises a first helical contact surface 211 that is helically formed parallel to the shank thread 222 of the shank threaded portion 220. The other of the opposing surfaces 211, 212 comprises a second helical contact surface 212, which is inclined reversely to the inclination of the first helical contact surfaces 211. Thus, the shank end face 208 of the shank 200, which faces toward the cutting head 100, is not flat due to the opposing surfaces 211, 212. The first and second helical contact surfaces 211, 212 are alternatingly arranged. Specifically, one or more first helical contact surfaces 211 and one or more second helical contact surfaces 211, 212 may be alternatingly arranged. When the cutting head 100 is coupled to the shank 200, the first helical head surfaces 111 of the cutting head 100 come into surface contact with the first helical contact surfaces 211 of the shank 200, while the second helical head surfaces 112 of the cutting head 100 come into surface contact with the second helical contact surfaces 212 of the shank 200. That is, the first and second helical head surfaces have a shape corresponding to the first and second contact surfaces, respectively.

FIGS. 2 and 3 show an example wherein the head threaded portion 120 comprises a threaded bore 125 formed in the cutting head 100 and the shank threaded portion 220 comprises a projection 225 formed in the shank 200. The arrangement of the threaded bore and the projection may be reverse to the foregoing example. In some embodiment, the projection may be provided in the cutting head 100 and the threaded bore may be provided in the shank 200.

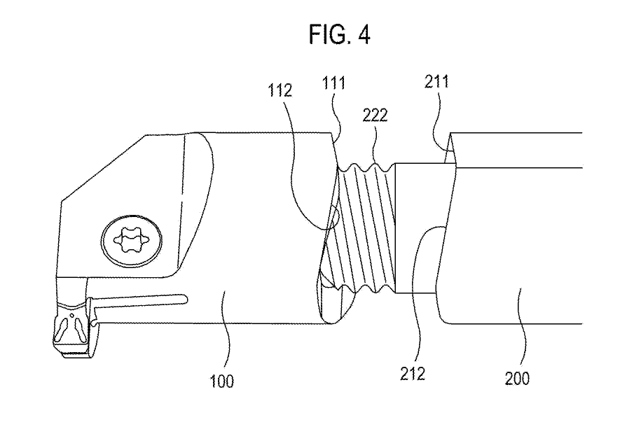

FIGS. 4 to 6 show an exemplary coupling between cutting head 100 to the shank 200 in sequence. FIG. 4 shows that the cutting head 100 is positioned coaxially with the shank 200 before coupling. As shown in FIG. 4, the first helical head surface 111 of the cutting head 100 is parallel to the shank thread 222 of the shank 200. Accordingly, as the head threaded portion 120 screw-engages the shank threaded portion 220, a first protruding intersection 113 where the first helical head surface 111 meets the second helical head surface 112 moves through a helical trajectory. This helical trajectory is parallel to the shank thread 222 of the shank 200.

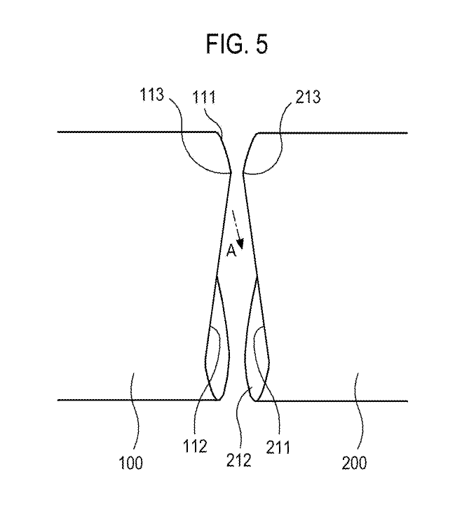

As shown in FIG. 5, while the head threaded portion 120 screw-engages the shank threaded portion 220, the first protruding intersection 113 is opposed to a second protruding intersection 213 where the first helical contact surface 211 meets the second helical contact surface 212. Thereafter, as the head threaded portion 120 continues to screw-engage the shank threaded portion 220, the first protruding intersection 113 moves in a direction of an arrow A shown in FIG. 5. As a result, the first helical head surface 111 comes into surface contact with the first helical contact surface 211. The first helical head surface 111 and the first helical contact surface 211 are parallel to the thread. Thus, during the screw-engagement of the head threaded portion 120 until the second helical head surface 112 comes into surface contact with the second helical contact surface 212, the first helical head surface 111 comes into further surface contact with the first helical contact surface 211. When a pressing force presses or pushes the first helical head surface 111 and the first helical contact surface 211 against each other, the coupling between the cutting head 100 and the shank 200 become firmer. Firmer coupling between the cutting head 100 and the shank 200 can be achieved due to a strong frictional force between the various helical surfaces caused by the pressing force as well as an increased frictional force in the screw-engagement obtained by a spare locking (described below) when the head threaded portion or the shank threaded portion is elastically deformed.

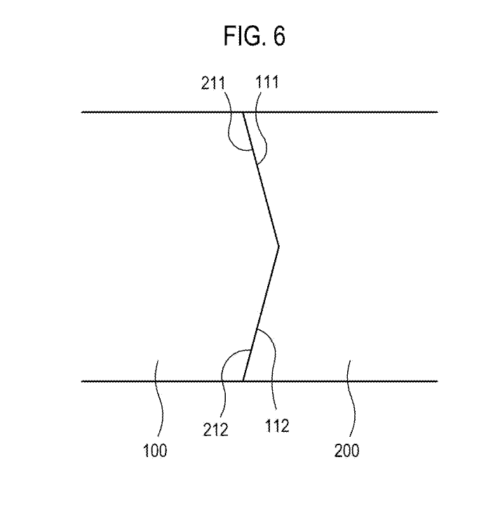

FIG. 6 shows that the cutting head 100 is fully coupled to the shank 200. In a state shown in FIG. 6, the second helical head surface 112 of the cutting head 100 is in surface contact with the second helical contact surface 212 of the shank 200. In the instant when the second helical head surface 112 comes into surface contact with the second helical contact surface 212 during the screw-engagement of the first and shank threaded portions, the second helical contact surface 212 of the shank 200 serves as a stopper that prevents the further rotation of the cutting head 100. Thus, the stopper stops the rotation of the cutting head 100. Accordingly, the cutting head 100 is exactly situated in a predetermined position. The cutting head 100 is firmly coupled to the shank 200 by virtue of the surface contact between the first helical head surface 111 and the first helical contact surface 211 as well as the surface contact between the second helical head surface 112 and the second helical contact surface 212. Accordingly, without the need to use a part such as a clamp screw, the cutting head 100 can be coupled to the shank 200 at all times in an exact position. Further, when decoupling the cutting head 100 from the shank 200, the cutting head 100 can be easily decoupled from the shank 200 only by rotating the cutting head 100 in a direction opposite to the direction of the screw-engagement, after which it can be easily replaced.

The cutting head 100 and the shank 200, which have the surface contact between the helical head surfaces parallel to the threads and the helical contact surfaces inclined reversely to the inclination of the helical head surfaces, provide another advantage. For example, if a contact surface between the cutting head and the shank is a single plane perpendicular to the axial direction, even if the screw-engagement between the cutting head and the shank is finished, the cutting head may further rotate relative to the shank. Regarding the screw-engagement between a male screw and a female screw, if an additional strong force or moment is applied to the male screw or the female screw, then a tensile force acts on the male screw or the female screw and thus causes an elastic deformation to the male screw or the female screw. This phenomenon is generally referred to as a spare locking. If spare locking occurs, then the frictional force between the elastically deformed male and female screws increases, thus reinforcing the screw-engagement. When the strong moment is applied to the cutting head and the shank, which come into surface contact with each other in a single perpendicular plane, the spare locking occurs between the cutting head and the shank. If so, the cutting head cannot be situated in a desired position. Further, the coupling position of the cutting head can vary depending on the intensity of the coupling force applied by the user. To cope with this problem, an additional element or component must be provided between the cutting head and the shank.

In this regard, it can be considered to provide an additional stopper to the contact surface of a perpendicular plane. In such a case, a stress concentrates on the proximity of the stopper and a stable coupling cannot be accomplished. However, according to the embodiment wherein the first helical head surface parallel to the thread and the second helical head surface inclined reversely to the first helical head surface are brought into surface contact with corresponding helical contact surfaces on the shank, the cutting head and the shank can come into surface contact with each other in their entirety and produce uniform support forces at the contact surfaces therebetween, thereby accomplishing a firmer and more stable coupling therebetween.

In the example wherein the stopper is provided in the contact surface of a single perpendicular plane between the cutting head and the shank, the spare locking may occur before the cutting head reach the stopper. Then, the stopper does not ensure that the cutting head is coupled to the shank in an exact position. However, the helical head surfaces parallel to the thread ensure that the cutting head reaches the stopper and is then coupled to the shank at all times in a desired position. Further, even if a spare locking occurs during coupling between the cutting and the shank, a force required for the spare locking is predictable and uniform.

An additional coupling force may occur between the cutting head and the shank after the cutting head is coupled to the shank. Further, a moment may be applied to the cutting head by a cutting force during a cutting operation. In case the cutting head is further rotated under such a circumstance, the second helical head surface of the cutting head must climb over the second helical contact surface of the shank. In this case, the coupling force in the axial direction significantly increases between the cutting head and the shank. Accordingly, the surface contact between the second helical head surfaces of the cutting head and the second helical contact surfaces of the shank provides a strong resistant force against the moment.

FIG. 7 shows that the cutting head 100 is coupled to the shank 200. The cylindrical bore 121 as the centering means of the cutting head 100 and the cylindrical portion 221 as the centering means of the shank 200 are aligned with each other and effectuate the centering between the cutting head and the shank. The cylindrical bore 121 and the cylindrical portion 221 may be reversely arranged depending upon the position of the male and female screws formed in the cutting head and the shank. For example, the cutting head may include the male screw formed with the cylindrical portion, while the shank may include the female screw formed with the cylindrical bore. FIG. 7 depicts the cylindrical bore and the cylindrical portion as the centering means of the cutting head 100 and the shank 200 having a constant diameter. Alternatively, the cylindrical bore and the cylindrical portion may each have a diameter that varies in the axial direction or have a tapered shape.

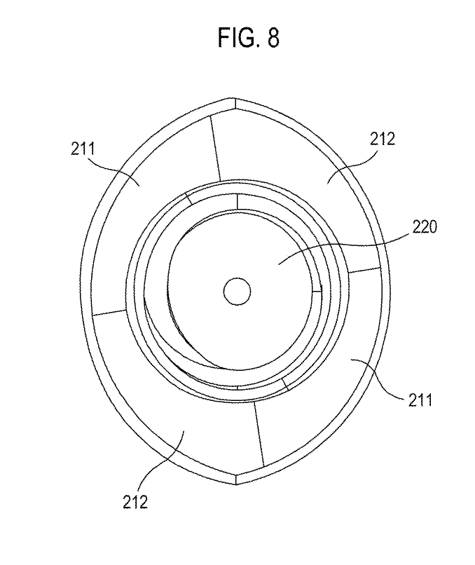

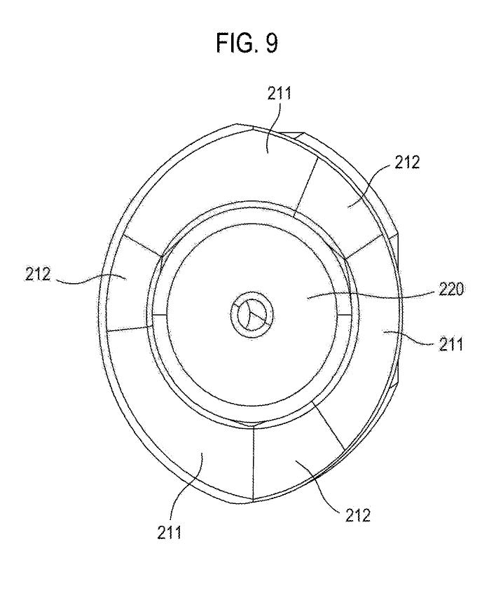

FIGS. 8 and 9 show shanks according to another embodiment. FIG. 8 shows a shank 200 including two first helical contact surfaces 211 and two second helical contact surfaces 212, which are alternatingly formed. FIG. 9 shows a shank 200 including three first helical head surfaces 211 and three second helical head surfaces 212, which are alternatingly formed. The cutting head may have as many first helical head surfaces as the first helical contact surfaces of the shanks shown in FIGS. 8 and 9 and as many second helical head surfaces as the second helical contact surfaces of the shanks shown in FIGS. 8 and 9. It is preferred that the first and second helical head surfaces 111, 112 of the cutting head 100 and the first and second helical contact surfaces 211, 212 of the shank 200 are three or more, as shown in FIG. 9. In such a case, when a force or moment is applied to the cutting head and the shank in any direction during the cutting operation, the shank can stably support the cutting head by virtue of the surface contact in three or more contact surfaces.

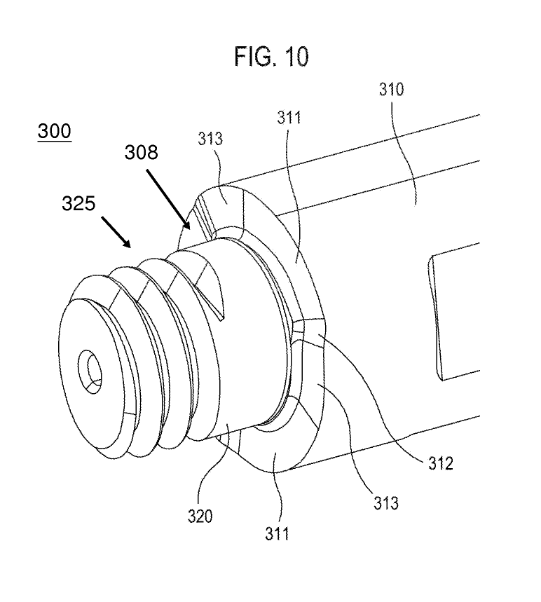

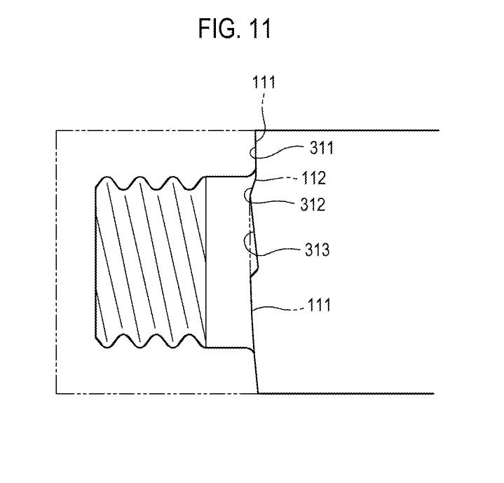

FIG. 10 shows a shank including a non-contact surface according to another embodiment. As shown in FIG. 10, the shank 300 includes a projection 325 having a shank threaded portion 320, and a circumferentially extending shank end face 308 surrounding the projection 325. The shank end face 308 includes a first helical contact surface 311, a second helical contact surface 312 and a non-contact surface 313. The first helical contact surface 311, the second helical contact surface 312 and the non-contact surface 313 may be arranged repeatedly in such an order. The non-contact surface 313 is offset from the first helical contact surface 311. As shown in FIG. 11, when the cutting head 100 is coupled to the shank 300, the first helical head surface 111 of the cutting head 100 comes into surface contact with the first helical contact surface 311, but does not come into surface contact with the non-contact surface 313. The non-contact surface 313 may comprise any helical or curved surface which is not in contact with the cutting head 100 when the cutting head is coupled to the shank. The non-contact surface 313 can decrease a contact area between the first helical head surface 111 and the first helical contact surface 311 when the cutting head is coupled to or decoupled from the shank. When the contact area between the first helical head surface 111 and the first helical contact surface 311 decreases due to the non-contact surface 313, the cutting head can be easily coupled to or decoupled from the shank 300. Especially, a great frictional force between the first helical head surface 111 and the first helical contact surface 311 may cause a strong spare locking due to the surface contact between the first helical head surface 111 and the first helical contact surface 311. Even in this case, the cutting head 100 can be easily coupled to the shank 300 due to the non-contact surface 313. Further, an offset degree can be suitably adjusted by controlling the size of the non-contact surface 313. Further, the non-contact surfaces may be formed at either side of the contact surfaces. In such a case, the frictional force can be adjusted when coupling the cutting head to the shank as well as when decoupling the cutting head from the shank. FIGS. 10 and 11 illustrate that the shank 300 has the non-contact surface 313. In some embodiment, the cutting head may have the non-contact surface or both the cutting head and the shank may have the non-contact surface.

According to the foregoing embodiments, the cutting head can be coupled to the shank through screw-engagement without the need to use an additional part. Further, the cutting head can be coupled to the shank in a constant position by virtue of the surface contact between the first helical head surface and the first helical contact surface parallel to the thread as well as the surface contact between the second helical head surface and the second helical contact surface inclined reversely to the thread. This ensures stable and firm coupling between the cutting head and the shank and easy replacement of the cutting head.

Although embodiments have been described with reference to a number of illustrative embodiments thereof, it should be understood that various other modifications and embodiments can be devised by those skilled in the art that will fall within the spirit and scope of the principles of this disclosure. More particularly, numerous variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A cutting tool, comprising:
a cutting head; and
a shank coupled to the cutting head, wherein the cutting head comprises:
a body extending in an axial direction and having a rear end facing the shank;
a head threaded portion having a thread, the head threaded portion projecting or being recessed in the axial direction from the rear end;
a first helical head surface parallel to a helix of the thread of the head threaded portion at the rear end of the body; and
a second helical head surface inclined in a direction reverse to the first helical head surface and disposed alternatingly with the first helical head surface at the rear end of the body,
wherein the shank comprises:
a cylindrical portion extending in the axial direction and having a forward end facing toward the cutting head;
a shank threaded portion extending in the axial direction from the forward end of the cylindrical portion, the shank threaded portion screw-engaging the head threaded portion;
a first helical contact surface formed at the forward end of the cylindrical portion, the first helical contact surface corresponding to the first helical head surface of the cutting head; and
a second helical contact surface corresponding to the second helical head surface of the cutting head and disposed alternatingly with the first helical contact surface at the forward end of the cylindrical portion,
wherein when the cutting head is coupled to the shank, the first helical head surface comes into surface contact with the first helical contact surface and the second helical head surface comes into surface contact with the second helical contact surface.

2. The cutting tool of claim 1, wherein the cutting head comprises three or more first helical head surfaces and three or more second helical head surfaces.

3. The cutting tool of claim 1, wherein the head threaded portion and the shank threaded portion each comprise a centering means centering the cutting head and the shank.

4. The cutting tool of claim 1, wherein the shank further comprises one or more non-contact surfaces at the forward end of the cylindrical portion, and
wherein, when the cutting head is coupled to the shank, the cutting head does not come into surface contact with the one or more non-contact surfaces.

5. The cutting tool of claim 1, wherein the cutting head further comprises one or more non-contact surfaces at the rear end of the body, and
wherein, when the cutting head is coupled to the shank, the shank does not come into surface contact with the one or more non-contact surfaces.

6. The cutting tool of claim 1, wherein the cutting head comprises one or more cutting edges integrally formed therewith.

7. The cutting tool of claim 1, wherein the cutting head comprises one or more cutting inserts replaceably mounted to the cutting head.

8. The cutting tool of claim 1, wherein when the cutting head is coupled to the shank, the first helical head surface and the first helical contact surface are coupled under pressure against each other.

9. A cutting head for detachably coupling to a shank of a cutting tool, comprising:
a body extending in an axial direction and having a rear end;
a head threaded portion having a thread, the head threaded portion projecting or being recessed in the axial direction from the rear end of the body;
a first helical head surface parallel to a helix of the thread of the head threaded portion at the rear end; and
a second helical head surface inclined reversely to the first helical head surface and disposed alternatingly with the first helical head surface at the rear end;
wherein the first and second helical head surfaces are configured to come into surface contact with opposing surfaces of the shank, when the cutting head is detachably coupled to a shank.

10. The cutting head of claim 11, wherein:
the cutting head further comprises one or more non-contact surfaces at the rear end of the body, and
wherein the one or more non-contact surfaces are configured to not come into contact with a shank, when the cutting head is detachably coupled to a shank.

11. A cutting tool shank for detachably coupling to a cutting head, comprising:
a cylindrical portion extending in an axial direction and having a forward end;
a shank threaded portion having a thread, the shank threaded portion projecting or being recessed in the axial direction from the forward end;
a first helical contact surface parallel to the thread of the shank threaded portion at the forward end; and
a second helical contact surface inclined reversely to the first helical head surface and disposed alternatingly with the first helical contact surface at the forward end,
wherein the first and second helical contact surfaces are configured to come into surface contact with opposing surfaces of a cutting head, when a cutting head is detachably coupled to the shank.

12. The cutting tool shank of claim 11, wherein:
the shank further comprises one or more non-contact surfaces at the forward end of the cylindrical portion, and
wherein the one or more non-contact surfaces are configured to not come into contact with a cutting head, when a cutting head is detachably coupled to the shank.
